(19) United States
(12) Patent Application Publication
(10) Pub. No.: US 2022/0366291 A1
(43) Pub. Date: Nov. 17, 2022

(54) METHODS AND APPARATUSES FOR PARAMETER OPTIMIZATION AND QUANTUM CHIP CONTROL

(71) Applicant: Alibaba Singapore Holding Private Limited, Singapore (SG)

(72) Inventor: Xiaotong NI, Hangzhou (CN)

(21) Appl. No.: 17/661,126

(22) Filed: Apr. 28, 2022

(30) Foreign Application Priority Data
May 11, 2021 (CN) 202110512605.9

(51) Int. Cl. G06N 10/40; G06N 10/20

(52) U.S. Cl. CPC G06N 10/40; G06N 10/20

(57) ABSTRACT

Methods, apparatuses, and systems include: obtaining a quantum gate precision corresponding to a quantum chip; performing a reverse differentiation operation on the quantum gate precision to obtain a gradient of a chip parameter and a gradient of a control parameter, wherein the chip parameter and the control parameter are configured to control the quantum chip to perform operations, updating the chip parameter based on the gradient of the chip parameter, and updating the control parameter based on the gradient of the control parameter.

### CROSS-REFERENCE TO RELATED APPLICATIONS

This disclosure claims priority to Chinese Application 202110512605.9, filed on May 11, 2021, the content of which is incorporated herein by reference in its entirety.

### TECHNICAL FIELD

This disclosure relates to the field of quantum technology, and in particular, to methods and apparatuses for parameter optimization and quantum chip control.

### BACKGROUND

A quantum chip is a chip that integrates quantum circuits on a substrate and processes quantum information. In the field of quantum computing, quantum chips are controlled to implement quantum gate operations and run quantum algorithms. In the process of controlling the quantum chips, parameters used for identifying quantum gate performance (including a chip parameter and a control parameter) have a direct impact on the precision of quantum gates and the accuracy of quantum algorithm results. Therefore, it is necessary to optimize the chip parameter and the control parameter.

### SUMMARY OF THE DISCLOSURE

The present disclosure methods, systems and non-transitory computer-readable media for parameter optimization and quantum chip control. In one example embodiment, a non-transitory computer-readable medium is provided, which stores a set of instructions that is executable by at least one processor of an apparatus to cause the apparatus to perform a method. The method includes obtaining a quantum gate precision corresponding to a quantum chip; performing a reverse differentiation operation on the quantum gate precision to obtain a gradient of a chip parameter and a gradient of a control parameter, wherein the chip parameter and the control parameter are configured to control the quantum chip to perform operations; updating the chip parameter based on the gradient of the chip parameter; and updating the control parameter based on the gradient of the control parameter.

In another example embodiment, a non-transitory computer-readable medium is provided, which stores a set of instructions that is executable by at least one processor of an apparatus to cause the apparatus to perform a method. The method includes obtaining a chip parameter and a control parameter, the chip parameter and the control parameter being configured to control a quantum chip to perform operations; generating a Hamiltonian based on the chip parameter and the control parameter; and controlling, based on the Hamiltonian and the control parameter, the quantum chip to perform an operation.

In another example embodiment, a non-transitory computer-readable medium is provided, which stores a set of instructions that is executable by at least one processor of an apparatus to cause the apparatus to perform a method. The method includes in response to a request for invoking parameter optimization, determining a processing resource corresponding to a parameter optimization service; and based on the processing resource, performing: obtaining a quantum gate precision corresponding to a quantum chip; performing a reverse differentiation operation on the quantum gate precision to obtain a gradient of a chip parameter and a gradient of a control parameter, wherein the chip parameter and the control parameter are configured to control the quantum chip to perform operations; updating the chip parameter based on the gradient of the chip parameter; and updating the control parameter based on the gradient of the control parameter.

In another example embodiment, a non-transitory computer-readable medium is provided, which stores a set of instructions that is executable by at least one processor of an apparatus to cause the apparatus to perform a method. The method includes in response to a request for invoking quantum chip control, determining a processing resource corresponding to a quantum chip control service; based on the processing resource, performing: obtaining a chip parameter and a control parameter, the chip parameter and the control parameter being configured to control a quantum chip to perform operations; generating a Hamiltonian based on the chip parameter and the control parameter; and controlling, based on the Hamiltonian and the control parameter, the quantum chip to perform an operation.

In another example embodiment, an apparatus is provided. The apparatus includes a memory configured to store a set of instructions and one or more processors communicatively coupled to the memory and configured to execute the set of instructions to cause the apparatus to: obtain a quantum gate precision corresponding to a quantum chip; perform a reverse differentiation operation on the quantum gate precision to obtain a gradient of a chip parameter and a gradient of a control parameter, wherein the chip parameter and the control parameter are configured to control the quantum chip to perform operations; update the chip parameter based on the gradient of the chip parameter; and update the control parameter based on the gradient of the control parameter.

In another example embodiment, an apparatus is provided. The apparatus includes a memory configured to store a set of instructions and one or more processors communicatively coupled to the memory and configured to execute the set of instructions to cause the apparatus to: obtain a chip parameter and a control parameter, the chip parameter and the control parameter being configured to control a quantum chip to perform operations; generate a Hamiltonian based on the chip parameter and the control parameter; and control, based on the Hamiltonian and the control parameter, the quantum chip to perform an operation.

In another example embodiment, an apparatus is provided. The apparatus includes a memory configured to store a set of instructions and one or more processors communicatively coupled to the memory and configured to execute the set of instructions to cause the apparatus to: in response to a request for invoking parameter optimization, determine a processing resource corresponding to a parameter optimization service; and based on the processing resource, perform: obtaining a quantum gate precision corresponding to a quantum chip; performing a reverse differentiation operation on the quantum gate precision to obtain a gradient of a chip parameter and a gradient of a control parameter, wherein the chip parameter and the control parameter are configured to control the quantum chip to perform operations; updating the chip parameter based on the gradient of the chip parameter; and updating the control parameter based on the gradient of the control parameter.

In another example embodiment, an apparatus is provided. The apparatus includes a memory configured to store a set of instructions and one or more processors communicatively coupled to the memory and configured to execute the set of instructions to cause the apparatus to: in response to a request for invoking quantum chip control, determine a processing resource corresponding to a quantum chip control service; based on the processing resource, perform: obtaining a chip parameter and a control parameter, the chip parameter and the control parameter being configured to control a quantum chip to perform operations; generating a Hamiltonian based on the chip parameter and the control parameter; and controlling, based on the Hamiltonian and the control parameter, the quantum chip to perform an operation.

In another example embodiment, a computer-implemented method for parameter optimization is provided. The computer-implemented method includes obtaining a quantum gate precision corresponding to a quantum chip; performing a reverse differentiation operation on the quantum gate precision to obtain a gradient of a chip parameter and a gradient of a control parameter, wherein the chip parameter and the control parameter are configured to control the quantum chip to perform operations; updating the chip parameter based on the gradient of the chip parameter; and updating the control parameter based on the gradient of the control parameter.

In another example embodiment, a computer-implemented method for parameter optimization is provided. The computer-implemented method includes obtaining a chip parameter and a control parameter, the chip parameter and the control parameter being configured to control the quantum chip to perform operations; generating a Hamiltonian based on the chip parameter and the control parameter; and controlling, based on the Hamiltonian and the control parameter, the quantum chip to perform an operation.

In another example embodiment, a computer-implemented method for parameter optimization is provided. The computer-implemented method includes in response to a request for invoking parameter optimization, determining a processing resource corresponding to a parameter optimization service; and based on the processing resource, performing: obtaining a quantum gate precision corresponding to a quantum chip; performing a reverse differentiation operation on the quantum gate precision to obtain a gradient of a chip parameter and a gradient of a control parameter, wherein the chip parameter and the control parameter are configured to control the quantum chip to perform operations; updating the chip parameter based on the gradient of the chip parameter; and updating the control parameter based on the gradient of the control parameter.

In another example embodiment, a computer-implemented method for parameter optimization is provided. The computer-implemented method includes in response to a request for invoking quantum chip control, determining a processing resource corresponding to a quantum chip control service; based on the processing resource, performing: obtaining a chip parameter and a control parameter, the chip parameter and the control parameter being configured to control a quantum chip to perform operations; generating a Hamiltonian based on the chip parameter and the control parameter; and controlling, based on the Hamiltonian and the control parameter, the quantum chip to perform an operation

### BRIEF DESCRIPTION OF THE DRAWINGS

Embodiments and various aspects of the present disclosure are illustrated in the following detailed description and the accompanying figures. Various features shown in the figures are not drawn to scale.

FIG. 1 is a flowchart of an example method of parameter optimization, consistent with some embodiments of this disclosure.

FIG. 2 is a schematic diagram illustrating a principle process of parameter optimization, consistent with some embodiments of this disclosure.

FIG. 3 is a flowchart of an example method of obtaining a quantum gate precision corresponding to a quantum chip, consistent with some embodiments of this disclosure.

FIG. 4 is a flowchart of another example method of obtaining a quantum gate precision corresponding to a quantum chip, consistent with some embodiments of this disclosure.

FIG. 5 is a flowchart of an example method of quantum chip control, consistent with some embodiments of this disclosure.

FIG. 6A is a flowchart of another example method of quantum chip control, consistent with some embodiments of this disclosure.

FIG. 6B is a schematic diagram illustrating a principle process of quantum chip control, consistent with some embodiments of this disclosure.

FIG. 7 is a schematic structural diagram of an example apparatus of parameter optimization, consistent with some embodiments of this disclosure.

FIG. 8 is a schematic structural diagram of an example electronic device corresponding to the example apparatus of FIG. 7.

FIG. 9 is a schematic structural diagram of an example apparatus of quantum chip control, consistent with some embodiments of this disclosure.

FIG. 10 is a schematic structural diagram of an example electronic device corresponding to the example apparatus of FIG. 9.

FIG. 11 is a flowchart of another example method of parameter optimization, consistent with some embodiments of this disclosure.

FIG. 12 is a schematic structural diagram of another example apparatus of parameter optimization, consistent with some embodiments of this disclosure.

FIG. 13 is a schematic structural diagram of an example electronic device corresponding to the example apparatus of FIG. 12.

FIG. 14 is a flowchart of yet another example method of quantum chip control, consistent with some embodiments of this disclosure.

FIG. 15 is a schematic structural diagram of yet another example apparatus of quantum chip control, consistent with some embodiments of this disclosure.

FIG. 16 is a schematic structural diagram of an example electronic device corresponding to the example apparatus of FIG. 15.

### DETAILED DESCRIPTION

To make the objectives, technical solutions and advantages of the embodiments of this disclosure clearer, the technical solutions in the embodiments of this disclosure will be described with reference to the accompanying drawings. The embodiments described are merely some embodiments, rather than all of the embodiments of this disclosure. All other embodiments obtained by a person of ordinary skill in the art based on the embodiments of this disclosure without creative efforts shall fall within the protection scope of this disclosure.

The terms used in the embodiments of this disclosure are merely for the purpose of illustrating specific embodiments and are not intended to limit this disclosure. The terms “a,” “said,” and “the” of singular forms used in the embodiments and the appended claims of this disclosure are also intended to include plural forms, unless otherwise specified in the context clearly. The term “a plurality of” generally includes at least two, but not exclude a situation of including at least one. Similarly, the use of a plural term does not necessarily denote a plurality unless it is unambiguous in the given context.

As used herein, unless specifically stated otherwise, the term “or” encompasses all possible combinations, except where infeasible. For example, if it is stated that a component can include A or B, then, unless specifically stated otherwise or infeasible, the component can include A, or B, or A and B. As a second example, if it is stated that a component can include A, B, or C, then, unless specifically stated otherwise or infeasible, the component can include A, or B, or C, or A and B, or A and C, or B and C, or A and B and C.

The term “and/or” used in this specification describes only an association relationship for describing associated objects and represents those three relationships can exist. For example, A and/or B can represent the following three cases: Only A exists, both A and B exist, and only B exists. In addition, the character “/” in this specification generally indicates an “or” relationship between the associated objects.

Depending on the context, for example, words “if” or “as if” used herein can be explained as “while . . . ” or “when . . . ” or “in response to determining” or “in response to detection”. Similarly, depending on the context, phrases “if determining” or “if detecting (a stated condition or event)” can be explained as “when determining” or “in response to determining” or “when detecting (the stated condition or event)” or “in response to detection (the stated condition or event)”.

It should be further noted that the words “comprising,” “having,” “containing,” and “including,” and other similar forms are intended to be equivalent in meaning and be open ended in that an item or items following any one of these words is not meant to be an exhaustive listing of such item or items or meant to be limited to only the listed item or items. Therefore, a merchandise or a system that includes a series of elements not only includes such elements, but also includes other elements not specified expressly, or but also includes inherent elements of the merchandise or the system. Unless otherwise specified, an element limited by “include a/an . . . ” does not exclude other same elements existing in the merchandise or the system that includes the element.

It should also be noted that the relational terms herein such as “first” and “second” are used only to differentiate an entity or operation from another entity or operation, and do not require or imply any actual relationship or sequence between these entities or operations. In addition, a step sequence in each of the following method embodiments is merely an example, but not a strict limitation.

A “computer,” as used herein, refers to a machine capable of executing instructions, calculations, computations, or algorithms for performing a series of ordered procedures or operations purporting to solve a task. Computers are ubiquitous in modern-day society, including direct involvement (e.g., smartphones and laptops) and indirect involvement (e.g., microcontrollers in cars or control systems in water purification plants). A computer must be implemented on some type of hardware (e.g., physical configuration of matter) subject to various limitations imposed by physics, which creates an upper bound on the computer's performance characteristics (e.g., amount of memory available or the number of operations-per-second allowed). Also, to solve a task, the computer must be provided with a set of instructions which, when followed, can cause the computer to accomplish the task.

A quantum computer, as used herein, refers to a computer that can perform quantum computations. Quantum computation in this disclosure refers to computation that uses quantum phenomena (e.g., superposition or entanglement) of hardware of the quantum computer. In contrast, a classical computer in this disclosure refers to a computer that cannot perform quantum computations, such as an electronic computer. Quantum computers can offer the ability to perform certain tasks deemed to be intractable to be solved by classical computers and provide unique advantages. For example, a quantum computer can be used to simulate dynamics of molecules (that are governed by quantum physics in nature), factorize integers (that underlies many cryptography theories), search unstructured data, optimize quantum annealing and adiabatic processes, accelerate machine learning algorithms, or perform many computational tasks that are deemed intractable for classical computers. Such technological advantages can benefit many industries and research, such as creation of new materials, synthesis of new pharmaceuticals, or development of energy-dense batteries.

A classical computer operates in digital logic. Digital logic, as used herein, refers to a logic system that operates on units of information (referred to as “bits”). A bit can have one of two values as the smallest unit of information, usually denoted by “0” and “1.” The digital logic can use digital logic gates to create, remove, or modify bits. Digital logic gates can be constructed using transistors, in which bits can be represented as voltage levels of wires connecting the transistors. A digital logic gate can take one or more bits as input and give one or more bits as output. For example, a logic AND gate can take two bits as input and gives one bit as output. The output of the AND gate can be “1” if the values of both inputs are “1,” and can be “0” if otherwise. By connecting inputs and outputs of various digital logic gates together in specific ways, a classical computer can implement arbitrarily complex algorithms to accomplish various computational tasks.

On a surface level, quantum computers operate in a similar way to classical computers. A quantum computer operates in quantum logic. Quantum logic, as used herein, refers to a system of logic that operates on units of information referred to as “qubits” or simply “qubits.” A qubit is the smallest unit of information in quantum computers, and can have any linear combination of two values, usually denoted |0> and |1>. The value of the qubit can be denoted |ψ>. Different from a digital bit that can have a value of either “0” or “1,” |ψ> can have a value of α|0>+β|1> where a and are complex numbers (referred to as “amplitudes”) not limited by any constraint except |α|²+|β|²=1. Qubits can be constructed in various forms and can be represented as quantum states of components of the quantum computer. For example, a qubit can be physically implemented using photons (e.g., in lasers) with their polarizations as the quantum states, electrons or ions (e.g., trapped in an electromagnetic field) with their spins as the quantum states, Josephson junctions (e.g., in a superconducting quantum system) with their charges, current fluxes, or phases as the quantum states, quantum dots (e.g., in semiconductor structures) with their dot spin as the quantum states, topological quantum systems, or any other system that can provide two or more quantum states. The quantum logic can use quantum logic gates (or simply “quantum gates”) to create, remove, or modify qubits.

Mathematically, a quantum gate is a propagator acting on a quantum state. Physically, a quantum gate can be implemented as a hardware device capable of generating laser pulses, electromagnetic waves (e.g., microwave pulses), electromagnetic fields, or any means for changing, maintaining, or controlling the quantum states of the qubits. A quantum gate, as used herein, refers to a logic unit or a hardware unit of a quantum computer that provides basic operations. A quantum gate can take one or more qubits as input and give one or more qubits as output, and thus can be represented as a matrix. Unlike classical logic gates (e.g., the AND gate), a quantum gate has a characteristic that its input can be determined based on its output and information of the transformation it applies, which is referred to as “reversible.” Such a reversible characteristic necessitates that the number of outputs of a quantum gate equal to or exceeds the number of its inputs and ensures that the input to a known quantum gate can always be constructed given its output.

The advantages of the quantum computers stem from their ability to lower the computational complexity for some tasks deemed to be intractable (e.g., mathematically possible, but physically unrealizable) for classical computers. Generally, a computational task can be conceptualized as determining a specific property of an instance of some mathematical objects (e.g., a graph, a number, or a string) representing the computational task, and the instance of the mathematical objects can be typically conceptualized as a sequence of bits (e.g., 1's and 0's). In general, larger instances requires more time or space to solve. The time or space required to solve the computational task depends on the size of the instance, which is usually taken to be the size of the input of the instance in bits. For example, the input to the instance can have a length of n. In such a context, the computational complexity of the computational task can be defined as the resources required by the best algorithm to determine the specific property of the instance of the mathematical objects.

A quantum chip, as used herein, refers to a chip that integrates quantum circuits on a substrate and is capable of processing quantum information. As used herein, a “Hamiltonian” refers to a quantity (e.g., an operator) for determining how a quantum system evolves over time. A Hamiltonian operator in the context of quantum physics can correspond to a Hamiltonian in classical physics. Typically, physical quantities in classical physics correspond to operators in quantum physics.

Precision of a quantum gate (or “quantum gate precision”) in this disclosure refers to a value representing a degree of agreement between a theoretical quantum gate (e.g., a designed quantum gate) and its corresponding actual realization (e.g., a corresponding actual quantum gate) in an experiment. Controlling of a quantum gate, as used herein, refers to an operation to generate a desired quantum gate by controlling variation of a Hamiltonian of the quantum gate over time. For example, a Hamiltonian of superconducting qubits over time can be generated using an electrical signal generated by a waveform generator. Robustness of a quantum gate, as used herein, refers to a rate at which precision of the quantum gate decreases when a control parameter or a chip parameter of the quantum gate deviates from a preset value.

Gradient optimization in this disclosure refers to a class of optimization algorithms characterized by acceleration of an optimization process by calculating a gradient of an objective function with an optimization parameter. An automatic gradient optimization framework, as used herein, refers to a software framework that can automatically calculate gradients and use the calculated gradients for optimization. Typically, such an automatic gradient optimization framework can speed up vector computations.

Some existing techniques can perform an operation of optimizing a chip parameter and a control parameter by fixing the chip parameter (that can affect the quantum gate precision and the accuracy of quantum algorithm results) and a Hamiltonian generated from the chip parameter and performing a gradient optimization operation on the control parameter. However, in the above-described techniques, because the chip parameter is manually configured as a fixed parameter, the gradient of the chip parameter can be difficult to be calculated, and therefore the chip parameter has challenges in its optimization based on the gradient of the chip parameter. Those challenges can make the optimization of the chip parameter inefficient and can reduce the precision of quantum gates and the accuracy of quantum algorithm results.

To solve the above-described technical problems, embodiments of this disclosure provide methods and apparatuses for parameter optimization and quantum chip control. In some embodiments, a quantum gate precision corresponding to a quantum chip can be obtained, and a reverse differentiation operation can be performed on the quantum gate precision to obtain a gradient of a chip parameter and a gradient of a control parameter, where the chip parameter and the control parameter can be used for controlling the quantum chip to perform operations. In this way, the gradient of the chip parameter used for identifying quantum gate performance and the gradient of the control parameter can be obtained simultaneously in a single process. Then, the chip parameter and the control parameter can be optimized based on the gradient of the chip parameter and the gradient of the control parameter to obtain an optimized chip parameter and an optimized control parameter, and the quantum chip can be controlled based on the optimized chip parameter and the optimized control parameter, which can effectively ensure the precision of control of the quantum chip.

The following describes some embodiments of this disclosure with reference to the accompanying drawings. Provided that there is no conflict between the embodiments, the following embodiments or the features in the embodiments can be combined with each other.

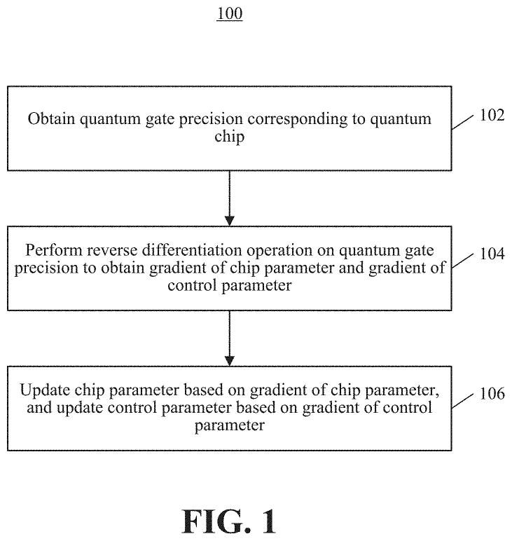

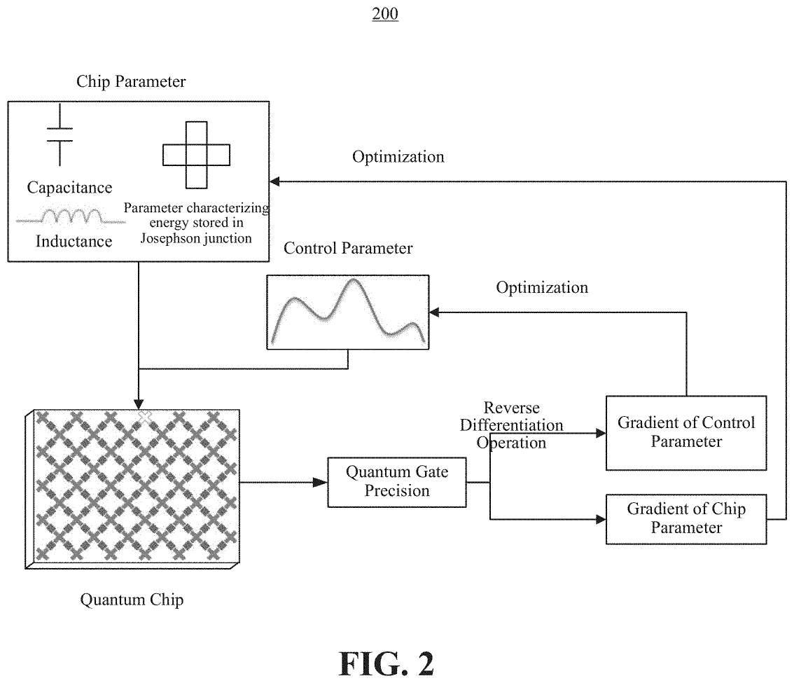

FIG. 1 is a flowchart of an example method 100 of parameter optimization, consistent with some embodiments of this disclosure. FIG. 2 is a schematic diagram illustrating a principle process 200 of parameter optimization, consistent with some embodiments of this disclosure. Method 100 can be executed by a parameter optimization apparatus. It can be understood that the parameter optimization apparatus can be implemented as software or a combination of software and hardware. As illustrated in FIG. 1, method 100 includes steps 102-106.

At step 102, a quantum gate precision corresponding to a quantum chip is obtained. In some embodiments, a chip parameter and a control parameter used for controlling the quantum chip can be preset. The chip parameter can be a parameter that cannot be changed during an operation of the quantum chip. Typically, the chip parameter can be correlated to structures of the quantum chip. For example, the chip parameter can include at least one of a capacitance corresponding to the quantum chip, an inductance corresponding to the quantum chip, or a parameter corresponding to the quantum chip and used for characterizing energy stored in a Josephson junction. In some embodiments, the control parameter can be a parameter that can be changed during the operation of the quantum chip. For example, the control parameter can include a waveform or one or more parameters of the waveform (e.g., a waveform amplitude, a waveform type, or the like), in which the waveform is used for controlling the quantum chip to perform an operation.

To obtain the quantum gate precision, in some embodiments, a simulate control operation can be performed on the quantum chip based on the preset chip parameter and the preset control parameter. In such a simulate control operation, after the quantum chip is controlled to operate, a quantum gate precision corresponding to the quantum chip can be obtained. The quantum gate precision can be correlated to accuracy of an operation result of the quantum chip. Typically, a higher quantum gate precision indicates a more accurate operation result of the quantum chip, and a lower quantum gate precision indicates a less accurate operation result of the quantum chip.

It should be noted that the chip parameter and the control parameter are not limited to the example parameters described above, and a person skilled in the art can also set the chip parameter and the control parameter to include other parameters according to specific application scenarios or application requirements. For example, the chip parameter can also include a parameter used for characterizing a coupling strength between any two qubits, a parameter used for characterizing a coupling strength between any two capacitors, or the like.

At step 104, a reverse differentiation operation is performed on the quantum gate precision to obtain a gradient of a chip parameter and a gradient of a control parameter. The chip parameter and the control parameter can be used for controlling the quantum chip to perform operations.

Because the quantum gate precision is correlated to the quality and accuracy of the operation results of the quantum chip, in some embodiments, the reverse differentiation operation can be performed on the quantum gate precision after the quantum gate precision is obtained, which can improve the quality and efficiency of operation of the quantum chip. For example, the reverse differentiation operation can be performed on the quantum gate precision using an automatic gradient optimization framework. The automatic gradient optimization framework can be a pre-generated or pre-trained software framework that can automatically calculate gradients and use the calculated gradients for optimization. By performing the reverse differentiation operation on the quantum gate precision using the automatic gradient optimization framework, the quality and efficiency of the reverse differentiation operation can be effectively ensured, so that the gradient of the chip parameter (e.g., a first-order derivative of the chip parameter) and the gradient of the control parameter (e.g., a first-order derivative of the control parameter) can be stably obtained.

At step 106, the chip parameter is updated based on the gradient of the chip parameter (e.g., to obtain an optimized chip parameter), and the control parameter is updated based on the gradient of the control parameter (e.g., to obtain an optimized control parameter). In some embodiments, the quantum chip can be controlled based on the updated (e.g., optimized) chip parameter and the updated (e.g., optimized) control parameter, by which the quality and efficiency of operation of the quantum chip can be improved. It can be understood that the parameter optimization operation (e.g., method 100) in this embodiment can be executed for once or for multiple times, and the number of times the parameter optimization operation is executed can be set according to specific application scenarios or design requirements as long as the operation effect of the quantum chip can meet the design requirements.

In the methods (e.g., method 100) for parameter optimization provided herein, a gradient of a chip parameter and a gradient of a control parameter can be obtained simultaneously by obtaining a quantum gate precision corresponding to a quantum chip and performing a reverse differentiation operation on the quantum gate precision. Also, an optimized chip parameter and an optimized control parameter can be obtained by optimizing (e.g., through updating) the chip parameter and the control parameter based on the gradient of the chip parameter and the gradient of the control parameter, respectively, thereby effectively achieving efficient parameter optimization. In addition, the quantum chip can be controlled based on the optimized chip parameter and the optimized control parameter, which can effectively ensure the precision of control of the quantum chip, thereby further improving the practicability of the disclosed methods for parameter optimization.

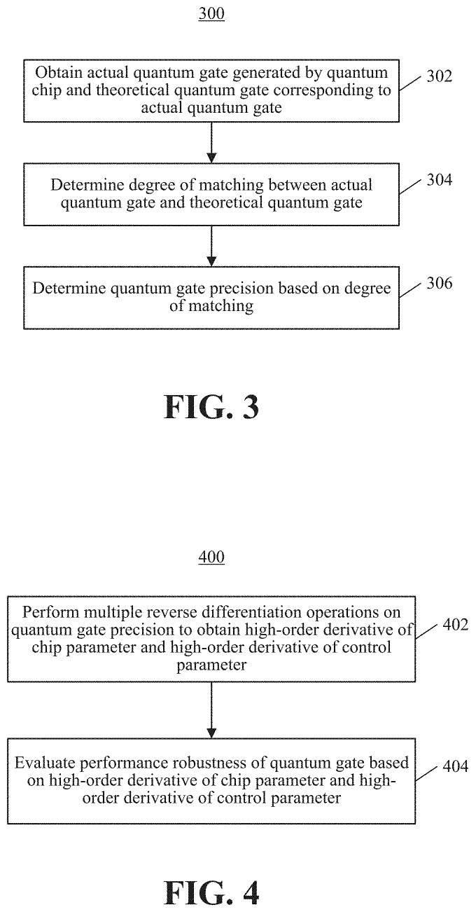

FIG. 3 is a flowchart of an example method 300 of obtaining a quantum gate precision corresponding to a quantum chip, consistent with some embodiments of this disclosure. For example, method 300 can be performed to implement step 102 of method 100 in FIG. 1. Method 300 includes steps 302-306.

At step 302, an actual quantum gate generated by the quantum chip and a theoretical quantum gate corresponding to the actual quantum gate are obtained. In some embodiments, the quantum chip can include various structures, such as, for example, a capacitor, an inductor, qubits, or a quantum gate acting on one or two qubits. After the structure of the quantum chip is determined, the operation of the quantum chip can be controlled based on configured chip parameters and control parameters to obtain the actual quantum gate.

In some embodiments, to obtain the actual quantum gate generated by the quantum chip, a chip parameter and a control parameter can be obtained. Based on the chip parameter and the control parameter, the quantum chip can be controlled to perform an operation to obtain the actual quantum gate.

For example, to obtain the actual quantum gate, the chip parameter and the control parameter can be obtained, in which both can be used for controlling the quantum chip. The manner to obtain the chip parameter and the control parameter is not limited in this disclosure. By way of example, the chip parameter and the control parameter can be stored in a preset area and can be obtained by accessing the preset area. In another example, the chip parameter and the control parameter can be stored in a third device. The apparatus configured to implement the parameter optimization method can be provided with a preset interface, through which the apparatus can communicate with the third device (e.g., in a wired or wireless manner) to obtain the chip parameter and the control parameter from the third device. In yet another example, the apparatus configured to implement the parameter optimization method can be provided with an interaction interface, and a user can input a to-be-executed operation through the interaction interface, so that the apparatus can generate the chip parameter and the control parameter based on the to-be-executed operation. In this way, the apparatus can stably obtain the chip parameter and the control parameter. The chip parameter and the control parameter can also be obtained in other manners, as long as the stability and reliability of obtaining the chip parameter and the control parameter can be ensured.

After the chip parameter and the control parameter are obtained, in some embodiments, the quantum chip can be controlled based on the chip parameter and the control parameter to perform an operation to obtain the actual quantum gate. For example, to control the quantum chip to perform the operation to obtain the actual quantum gate based on the chip parameter and the control parameter, a Hamiltonian can be generated based on the chip parameter and the control parameter. Then, the quantum chip can be controlled to perform the operation to obtain the actual quantum gate based on the Hamiltonian and the control parameter.

In some embodiments, the chip parameter can include at least one of a capacitance corresponding to the quantum chip, an inductance corresponding to the quantum chip, or a parameter corresponding to the quantum chip and used for characterizing energy stored in a Josephson junction. In such cases, a Hamiltonian can be generated based on the chip parameter and the control parameter by Eq. (1):

$$H = 4 {E}_{C} {\hat{n}}^{2} + \frac{1}{2} {E}_{L} {\hat{φ}}^{2} - {E}_{J} cos ( \hat{φ} - 2 π \frac{{Φ}_{e x t}}{{Φ}_{0}} ) \qquad Eq . ( 1 )$$

In Eq. (1), H represents the Hamiltonian. E_{C} represents the capacitance corresponding to the quantum chip. \hat{n} represents a quantum mechanics operator used for characterizing the number of electron charges in the capacitor. E_{L} represents the inductance corresponding to the quantum chip. represents a quantum mechanics operator used for characterizing a magnetic flux in an inductor. E_{J} represents the parameter corresponding to the quantum chip and used for characterizing the energy stored in the Josephson junction. Φₑₓₜ represents the control parameter. Φ₀ is a preset constant. The Hamiltonian H generated in accordance with Eq. (1) can be in the form of a matrix, by which the accuracy and reliability of the Hamiltonian generated can be effectively ensured.

After the Hamiltonian and the control parameter are obtained, the quantum chip can be controlled to perform an operation to obtain the actual quantum gate based on the Hamiltonian (e.g., H in Eq. (1)) and the control parameter (e.g., Φₑₓₜ in Eq. (1)). It can be understood that when the chip parameter and the control parameter are used to control the quantum chip to operate, there can be a mapping relationship between the chip parameter, the control parameter, and the theoretical quantum gate. Therefore, the theoretical quantum gate corresponding to the actual quantum gate can be determined based on the chip parameter and the control parameter.

In some embodiments, if the Hamiltonian is generated based on the chip parameter and the control parameter, the quantum chip can be controlled based on the Hamiltonian and the control parameter to obtain the quantum gate precision, and a reverse differentiation operation can be performed on the quantum gate precision to obtain the gradient of the chip parameter and the gradient of the control parameter. Both the obtained gradient of the chip parameter and the obtained gradient of the obtained control parameter are correlated to the Hamiltonian.

Still referring to FIG. 3, at step 304, a degree of matching is determined between the actual quantum gate and the theoretical quantum gate. After the actual quantum gate and the theoretical quantum gate are obtained at step 302, in some embodiments, the actual quantum gate and the theoretical quantum gate can be analyzed and matched against each other to obtain a degree of matching between the actual quantum gate and the theoretical quantum gate. The degree of matching between the actual quantum gate and the theoretical quantum gate can be correlated to the quantum gate precision.

At step 306, the quantum gate precision is determined based on the degree of matching. In some examples, the quantum gate precision can be positively correlated to the degree of matching. For example, a higher degree of matching between the actual quantum gate and the theoretical quantum gate can represent a higher quantum gate precision, and a lower degree of matching between the actual quantum gate and the theoretical quantum gate can represent a lower quantum gate precision. By performing method 300, the accuracy and reliability of the quantum gate precision determined can be effectively ensured.

FIG. 4 is a flowchart of another example method 400 of obtaining a quantum gate precision corresponding to a quantum chip, consistent with some embodiments of this disclosure. Method 400 can be performed in addition to any of methods 100-300 to further improve the practicability of any of methods 100-300. In method 400, the quantum gate precision can be used to identify performance of the quantum chip. In some embodiments, method 400 can be performed after completing step 102 of FIG. 1. Method 400 includes steps 402-404.

At step 402, in response to obtaining the quantum gate precision corresponding to the quantum chip, multiple reverse differentiation operations are performed on the quantum gate precision to obtain a high-order derivative of the chip parameter and a high-order derivative of the control parameter. The high-order derivative of the chip parameter and the high-order derivative of the control parameter can be correlated to the performance robustness of the quantum gate.

At step 404, performance robustness of a quantum gate corresponding to the quantum gate precision is evaluated based on the high-order derivative of the chip parameter and the high-order derivative of the control parameter. The high-order derivative of the chip parameter and the high-order derivative of the control parameter can be analyzed to evaluate the performance robustness of the quantum gate. For example, a rule for evaluating the performance robustness of the quantum gate can be configured in advance. The performance robustness of the quantum gate can be determined based on the rule, the high-order derivative of the chip parameter, and the high-order derivative of the control parameter. Then, the quantum chip can be optimized and adjusted based on the determined performance robustness of the quantum gate. By performing method 400, the operational performance of the quantum chip can be improved.

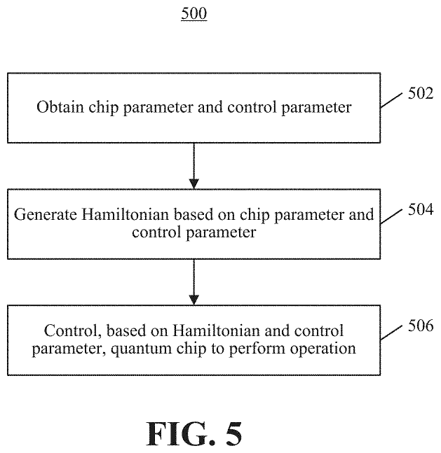

FIG. 5 is a flowchart of an example method 500 of quantum chip control, consistent with some embodiments of this disclosure. In some embodiments, method 500 can be executed by an apparatus for quantum chip control. It can be understood that the apparatus for quantum chip control can be implemented as software or a combination of software and hardware.

At step 502, a chip parameter and a control parameter are obtained. The chip parameter and the control parameter are configured to control a quantum chip to perform operations. In some embodiments, the chip parameters can be a parameter that cannot be changed (e.g., immutable) during operations of the quantum chip. The chip parameter can be correlated to a structure of the quantum chip. For example, the chip parameter can include at least one of a capacitance corresponding to the quantum chip, an inductance corresponding to the quantum chip, or a parameter corresponding to the quantum chip and used for characterizing energy stored in a Josephson junction. In some embodiments, the control parameter can be a parameter that can be changed during operations of the quantum chip. For example, the control parameter can include a waveform used for controlling the quantum chip to perform an operation.

It is noted that the manner in which the chip parameter and the control parameter are obtained is not limited in this disclosure. For example, the chip parameter and the control parameter can be stored in a preset area and can be obtained by accessing the preset area. In another example, the chip parameter and the control parameter can be stored in a third device. The apparatus configured to implement the quantum chip control method can be provided with a preset interface, through which the apparatus can communicate with the third device to obtain the chip parameter and the control parameter from the third device. In yet another example, the apparatus configured to implement the quantum chip control method can be provided with an interaction interface, and a user can input a to-be-executed operation through the interaction interface, so that the apparatus can generate the chip parameter and the control parameter based on the to-be-executed operation. In this way, the control apparatus can stably obtain the chip parameter and the control parameter. The chip parameter and the control parameter can also be obtained in other manners, as long as the stability and reliability of obtaining the chip parameter and the control parameter can be ensured.

At step 504, a Hamiltonian is generated based on the chip parameter and the control parameter. By way of example, the Hamiltonian can be generated in accordance with Eq. (1) and its associated description.

At step 506, the quantum chip is controlled to perform an operation based on the Hamiltonian and the control parameter. By way of example, the quantum chip is controlled to perform an operation to obtain an actual quantum gate as described in association with step 302 of FIG. 3. Because the Hamiltonian is correlated to the chip parameter and the control parameter, the control of the quantum chip based on the Hamiltonian and the control parameter described in association with method 500 can effectively ensure the precision of control of the quantum chip, thereby further improving the practicability of method 500.

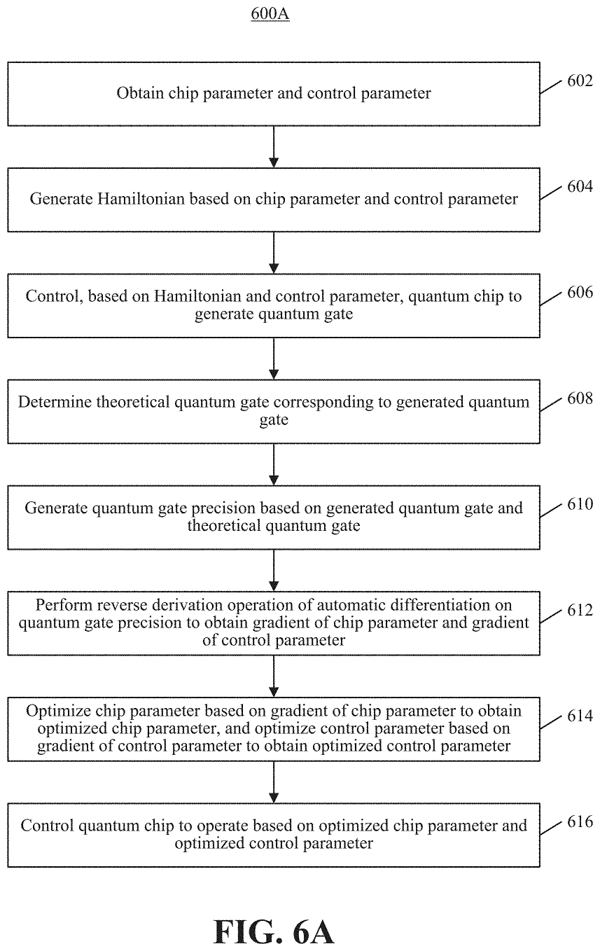

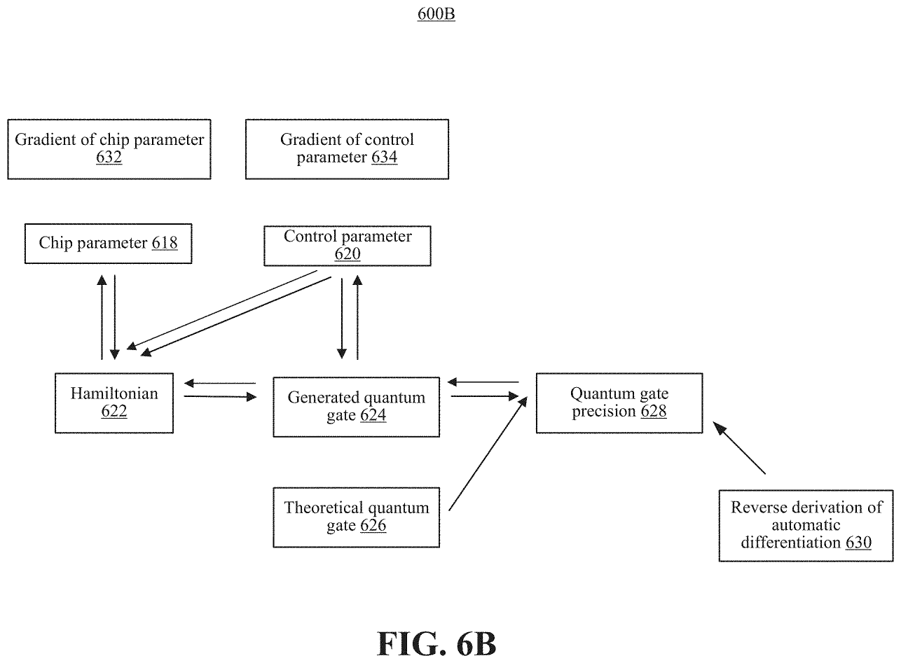

FIG. 6A is a flowchart of another example method 600A of quantum chip control, consistent with some embodiments of this disclosure. Method 600A includes a process of generating a Hamiltonian and a process of calculating a quantum gate precision. In some embodiments, the process of generating a Hamiltonian and the process of calculating a quantum gate precision can both be implemented by an automatic differentiation framework. For example, executable instructions for implementing method 600A can be written in the automatic differentiation framework using a language tool specified in the automatic differentiation framework, so that the operations of optimizing the relevant parameters of the quantum chip and controlling the quantum chip can be realized.

At step 602, a chip parameter and a control parameter are obtained. In some embodiments, step 602 can be implemented in the same manner as described in association with step 502 of FIG. 5.

At step 604, a Hamiltonian is generated based on the chip parameter and the control parameter. In some embodiments, step 604 can be implemented in the same manner as described in association with step 504. In some embodiments, step 604 can be implemented by an automatic differentiation framework.

At step 606, the quantum chip is controlled to generate a quantum gate based on the control parameter and the Hamiltonian. At step 608, a theoretical quantum gate corresponding to the generated quantum gate is determined.

At step 610, a quantum gate precision is generated based on the generated quantum gate and the theoretical quantum gate. In some embodiments, step 610 can be implemented by the automatic differentiation framework described in step 604.

At step 612, a reverse derivation operation of automatic differentiation is performed on the quantum gate precision to obtain a gradient of a chip parameter and a gradient of a control parameter.

At step 614, the chip parameter is optimized based on the gradient of the chip parameter to obtain an optimized chip parameter, and the control parameter is optimized based on the gradient of the control parameter to obtain an optimized control parameter. In some embodiments, step 614 can be implemented in the same manner as described in association with step 106 of FIG. 1.

At step 616, the quantum chip is controlled to operate based on the optimized chip parameter and the optimized control parameter.

In method 600A, the automatic differentiation framework can be used to perform only one reverse differentiation operation to simultaneously obtain the gradient of the chip parameter and the gradient of the control parameter for the quantum gate precision. By doing so, the chip parameter and the control parameter can be optimized more quickly based on the gradient of the chip parameter and the gradient of the control parameter, thereby further improving the stability and reliability of control of the quantum chip.

In some embodiments, after step 610, method 600A can further include additional steps. For example, after step 610, multiple reverse derivation operations of automatic differentiation can be performed on the quantum gate precision to obtain a high-order derivative of the chip parameter and a high-order derivative of the control parameter. Then, robustness of a quantum gate can be evaluated or optimized based on the high-order derivative of the chip parameter and the high-order derivative of the control parameter. Based on a result of the evaluation, stability of operation as well as performance of the quantum chip can be improved.

FIG. 6B is a schematic diagram illustrating a principle process 600B of quantum chip control, consistent with some embodiments of this disclosure. Process 600B can correspond to method 600A of FIG. 6A. Process includes stages 618-634, each stage represents input data, output data, or an operation.

At stage 622, a Hamiltonian can be generated (e.g., similar to step 606 of FIG. 6A) based on a chip parameter 618 and a control parameter 620. At stage 624, a quantum gate is generated based on control parameter 620 and the Hamiltonian generated at stage 622. At stage 626, a theoretical quantum gate corresponding to the quantum gate generated at stage 624 is determined. At stage 628, a quantum gate precision is generated based on the quantum gate generated at stage 624 and the theoretical quantum gate determined at stage 626. At stage 630, a reverse derivation operation of automatic differentiation is performed on the quantum gate precision generated at stage 628 to obtain a gradient of a chip parameter (referred to as “gradient 632”) and a gradient of a control parameter (referred to as “gradient 634”). Then, chip parameter 618 can be optimized based on gradient 632 to obtain an optimized chip parameter (not illustrated in FIG. 6B), and control parameter 620 can be optimized based on gradient 634 to obtain an optimized control parameter (not illustrated in FIG. 6B). After that, the quantum chip can be controlled to operate based on the optimized chip parameter and the optimized control parameter.

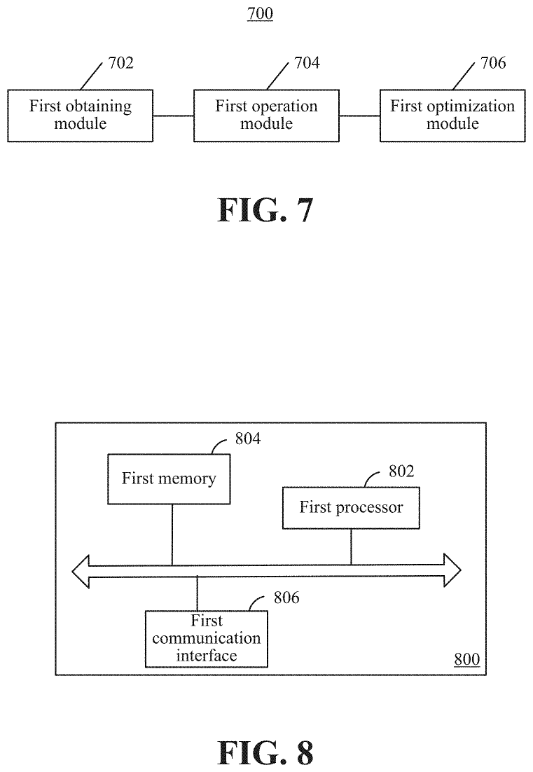

FIG. 7 is a schematic structural diagram of an example apparatus 700 of parameter optimization, consistent with some embodiments of this disclosure. For example, apparatus 700 can be used to execute method 100 described in association with FIG. 1. As depicted in FIG. 7, apparatus 700 can include a first obtaining module 702, a first operation module 704, and a first optimization module 706, each of which can be implemented as a software module or a hybrid module (e.g., a combination of software and hardware).

First obtaining module 702 can be used to obtain a quantum gate precision corresponding to a quantum chip. For example, first obtaining module 702 can be used to perform step 102 described in association with FIG. 1.

In some embodiments, to obtain the actual quantum gate generated by the quantum chip, first obtaining module 702 can obtain a chip parameter and a control parameter and control the quantum chip to perform an operation to obtain the actual quantum gate based on the chip parameter and the control parameter.

In some embodiments, to control the quantum chip to perform the operation to obtain an actual quantum gate based on the chip parameter and the control parameter, first obtaining module 702 can generate a Hamiltonian based on the chip parameter and the control parameter and control the quantum chip to perform the operation to obtain the actual quantum gate based on the Hamiltonian and the control parameter.

In some embodiments, the chip parameter can include at least one of a capacitance corresponding to the quantum chip, an inductance corresponding to the quantum chip, or a parameter corresponding to the quantum chip and used for characterizing energy stored in a Josephson junction. In some embodiments, the control parameter can include a waveform used for controlling the quantum chip to perform an operation. In some embodiments, the gradient of the control parameter can be correlated to the Hamiltonian.

Still referring to FIG. 7, first operation module 704 can be used to perform a reverse differentiation operation on the quantum gate precision to obtain a gradient of a chip parameter and a gradient of a control parameter. The chip parameter and the control parameter can be used for controlling the quantum chip to perform operations. For example, first operation module 704 can be used to perform step 104 described in association with FIG. 1. In some embodiments, to obtain the quantum gate precision corresponding to the quantum chip, first obtaining module 702 can be executed to obtain an actual quantum gate generated by the quantum chip and a theoretical quantum gate corresponding to the actual quantum gate, to determine a degree of matching between the actual quantum gate and the theoretical quantum gate, and to determine the quantum gate precision based on the degree of matching.

In some examples, after obtaining the quantum gate precision (that can be used for identifying performance of the quantum chip), first operation module 704 can further perform multiple reverse differentiation operations on the quantum gate precision to obtain a high-order derivative of the chip parameter and a high-order derivative of the control parameter. Then, first operation module 704 can evaluate performance robustness of a quantum gate based on the high-order derivative of the chip parameter and the high-order derivative of the control parameter.

First optimization module 706 can be used to update the chip parameter based on the gradient of the chip parameter, and to update the control parameter based on the gradient of the control parameter. For example, first optimization module 706 can be used to perform step 106 described in association with FIG. 1.

In some embodiments, apparatus 700 can perform all or parts of the steps in methods 100-400 and 600A-600B described in association with FIGS. 1-4 and FIGS. 6A-6B. For parts or technical effects not described in detail in association with FIG. 7, reference can be made to the relevant descriptions in association with FIGS. 1-4 and FIGS. 6A-6B.

Consistent with some embodiments of this disclosure, the structure of apparatus 700 in FIG. 7 can be implemented as an electronic device. For example, the electronic device can be a mobile phone, a tablet computer, a server, or any type of other electronic device.

By way of example, FIG. 8 is a schematic structural diagram of an example electronic device 800 corresponding to apparatus 700 of FIG. 7. As shown in FIG. 8, electronic device 800 includes a first processor 802, a first memory 804, and a first communication interface 806. First communication interface 806 can enable electronic device 800 to communicate with another device or a communication network. In some embodiments, first memory 804 can store a program for causing electronic device 800 to execute all or part of the steps in methods 100-400 and 600A-600B described in association with FIGS. 1-4 and FIGS. 6A-6B.

First processor 802 can execute program stored in first memory 804. The program can include one or more computer instructions. By way of example, the one or more computer instructions, when executed by first processor 802, can perform steps 102-106 described in association with FIG. 1.

Consistent with some embodiments of this disclosure, a non-transitory computer-readable storage medium can store computer software instructions for use by an electronic device (e.g., electronic device 800). The computer software instructions can include a program for executing all or part of the steps in methods 100-400 and 600A-600B described in association with FIGS. 1-4 and FIGS. 6A-6B.

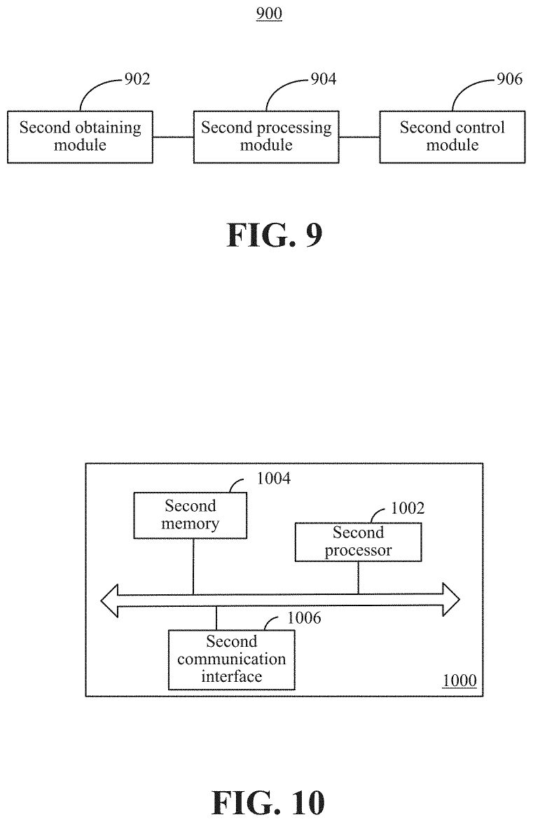

FIG. 9 is a schematic structural diagram of an example apparatus 900 of quantum chip control, consistent with some embodiments of this disclosure. In some embodiments, apparatus 900 can perform method 500 described in association with FIG. 5. Apparatus 900 includes a second obtaining module 902, a second processing module 904, and a second control module 906.

Second obtaining module 902 can obtain a chip parameter and a control parameter. The chip parameter and the control parameter can be used to control a quantum chip to perform operations. For example, second obtaining module 902 can be used to perform step 502 described in association with FIG. 5.

Second processing module 904 is configured to generate a Hamiltonian based on the chip parameter and the control parameter. For example, second processing module 904 can be used to perform step 504 described in association with FIG. 5.

Second control module 906 is configured to control the quantum chip to perform an operation based on the Hamiltonian and the control parameter. For example, second control module 906 can be used to perform step 506 described in association with FIG. 5.

In some embodiments, apparatus 900 can perform all or parts of the steps in methods 500, 600A and 600B described in association with FIGS. 5 and FIGS. 6A-6B. For parts or technical effects not described in detail in association with FIG. 9, reference can be made to the relevant descriptions in association with FIGS. 5 and FIGS. 6A-6B.

Consistent with some embodiments of this disclosure, the structure of apparatus 900 in FIG. 9 can be implemented as an electronic device. For example, the electronic device can be a mobile phone, a tablet computer, a server, or any type of other electronic device.

By way of example, FIG. 10 is a schematic structural diagram of an example electronic device 1000 corresponding to apparatus 900 of FIG. 9. As shown in FIG. 10, electronic device 1000 includes a second processor 1002, a second memory 1004, and a second communication interface 1006. Second communication interface 1006 can enable electronic device 1000 to communicate with another device or a communication network. In some embodiments, second memory 1004 can store a program for causing electronic device 1000 to execute all or part of the steps in methods 500, 600A and 600B described in association with FIGS. 5 and FIGS. 6A-6B.

Second processor 1002 can execute program stored in second memory 1004. The program can include one or more computer instructions. By way of example, the one or more computer instructions, when executed by first processor 802, can perform steps 502-506 described in association with FIG. 5.

Consistent with some embodiments of this disclosure, a non-transitory computer-readable storage medium can store computer software instructions for use by an electronic device (e.g., electronic device 1000). The computer software instructions can include a program for executing all or part of the steps in methods 500, 600A and 600B described in association with FIG. 5 and FIGS. 6A-6B.

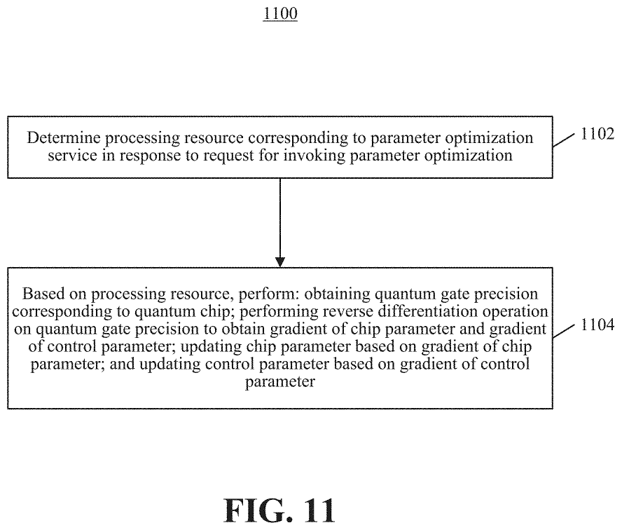

FIG. 11 is a flowchart of another example method 1100 of parameter optimization, consistent with some embodiments of this disclosure. In some embodiments, method 1100 can be executed by an apparatus for parameter optimization (e.g., apparatus 700 described in association with FIG. 7). It can be understood that the apparatus can be implemented as software or a combination of software and hardware.

Referring to FIG. 11, at step 1102, a processing resource corresponding to a parameter optimization service can be determined in response to a request for invoking parameter optimization.

At step 1104, the following steps are performed based on the processing resource. A quantum gate precision corresponding to a quantum chip can be obtained. Then, a reverse differentiation operation can be performed on the quantum gate precision to obtain a gradient of a chip parameter and a gradient of a control parameter, in which the chip parameter and the control parameter can be used for controlling the quantum chip to perform operations. After that, the chip parameter can be updated based on the gradient of the chip parameter (e.g., to obtain an optimized chip parameter), and the control parameter can be updated based on the gradient of the control parameter (e.g., to obtain an optimized control parameter).

In some embodiments, all or part of the methods (e.g., methods 100-400, 600A-600B, and 1100) for parameter optimization described in this disclosure can be executed in a cloud. For example, multiple computing nodes can be deployed in the cloud, and each computing node can have processing resources (e.g., computing resources or storage resources). In the cloud, multiple computing nodes can be organized to provide a certain service. Each computing node can provide one or more services.

In some embodiments, the cloud can provide a service for implementing the method of parameter optimization, which can be referred to as a parameter optimization service. When a user needs to use the parameter optimization service, the parameter optimization service can be invoked to trigger a request for invoking the parameter optimization service to the cloud.

By way of example, the cloud can determine a computing node for responding to the request and can further perform the steps described in association with step 1104 of FIG. 11 based on the processing resource in the computing node. In some embodiments, the implementation process, implementation principle, and implementation effects of method 1100 can be similar to methods 100-400 and 600A-600B described in association with FIGS. 1-4 and FIGS. 6A-6B. For parts or technical effects not described in detail in association with FIG. 11, reference can be made to the relevant descriptions in association with FIGS. 1-4 and FIGS. 6A-6B.

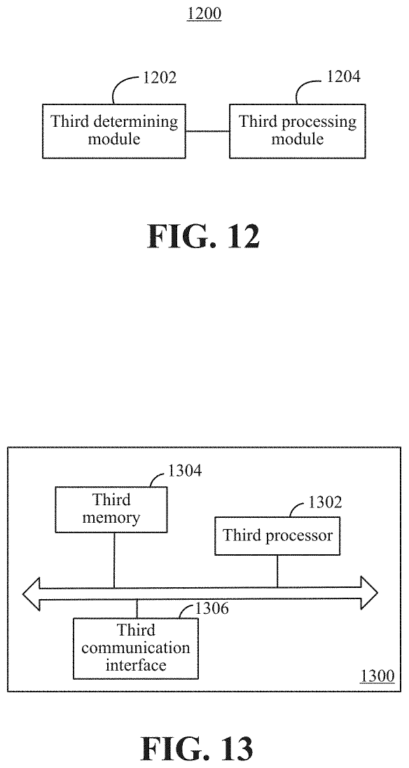

FIG. 12 is a schematic structural diagram of another example apparatus 1200 of parameter optimization, consistent with some embodiments of this disclosure. In some embodiments, apparatus 1200 can execute method 1100 described in association with FIG. 11. For parts or technical effects not described in detail in association with FIG. 12, reference can be made to the relevant descriptions in association with FIG. 11.

Apparatus 1200 can include a third determining module 1202 and a third processing module 1204. Third determining module 1202 is configured to determine a processing resource corresponding to a parameter optimization service in response to a request for invoking parameter optimization. Third processing module 1204 is configured to perform the following steps based on the processing resource. A quantum gate precision corresponding to a quantum chip can be obtained. Then, a reverse differentiation operation can be performed on the quantum gate precision to obtain a gradient of a chip parameter and a gradient of a control parameter, in which the chip parameter and the control parameter can be used for controlling the quantum chip to perform operations. After that, the chip parameter can be updated based on the gradient of the chip parameter (e.g., to obtain an optimized chip parameter), and the control parameter can be updated based on the gradient of the control parameter (e.g., to obtain an optimized control parameter).

Consistent with some embodiments of this disclosure, the structure of apparatus 1200 in FIG. 12 can be implemented as an electronic device. For example, the electronic device can be a mobile phone, a tablet computer, a server, or any type of other electronic device.

By way of example, FIG. 13 is a schematic structural diagram of an example electronic device 1300 corresponding to apparatus 1200 of FIG. 12. As shown in FIG. 13, electronic device 1300 includes a third processor 1302, a third memory 1304, and a third communication interface 1306. Third communication interface 1306 can enable electronic device 1300 to communicate with another device or a communication network. In some embodiments, third memory 1304 can store a program for causing electronic device 1300 to execute all or part of the steps in method 1100 described in association with FIG. 11.

Third processor 1302 can execute program stored in third memory 1304. The program can include one or more computer instructions. By way of example, the one or more computer instructions, when executed by third processor 1302, can perform steps 1102-1104 described in association with FIG. 11.

Consistent with some embodiments of this disclosure, a non-transitory computer-readable storage medium can store computer software instructions for use by an electronic device (e.g., electronic device 1300). The computer software instructions can include a program for executing all or part of the steps in method 1100 described in association with FIGS. 11.

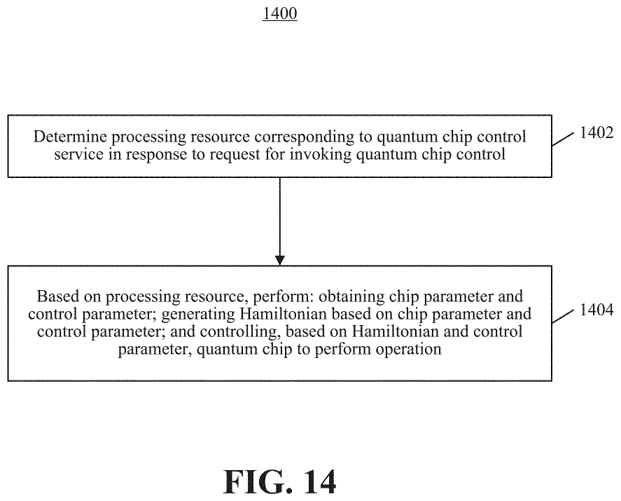

FIG. 14 is a flowchart of yet another example method 1400 of quantum chip control, consistent with some embodiments of this disclosure. In some embodiments, method 1400 can be executed by an apparatus for quantum chip control. It can be understood that the apparatus for quantum chip control can be implemented as software or a combination of software and hardware.

At step 1402, a processing resource corresponding to a quantum chip control service can be determined in response to a request for invoking quantum chip control.

At step 1404, based on the processing resource, the following steps can be performed. A chip parameter and a control parameter can be obtained, both of which can be used for controlling the quantum chip to perform operations. A Hamiltonian can be generated based on the chip parameter and the control parameter. Based on the Hamiltonian and the control parameter, the quantum chip can be controlled to perform an operation.

In some embodiments, the method for quantum chip control (e.g., method 1400) provided in this disclosure can be executed in a cloud. Multiple computing nodes can be deployed in the cloud, and each computing node can have processing resources (e.g., computing resources and storage resources). In the cloud, multiple computing nodes can be organized to provide a certain service. Each computing node can provide one or more services.

In some embodiments, the cloud can provide a service for implementing the method of quantum chip control, which can be referred to as a quantum chip control service. When a user needs to use the quantum chip control service, the quantum chip control service can be invoked to trigger a request for invoking the quantum chip control service to the cloud.

By way of example, the cloud can determine a computing node for responding to the request and can further perform the steps described in association with step 1404 of FIG. 14 based on the processing resource in the computing node. In some embodiments, the implementation process, implementation principle, and implementation effects of method 1400 can be similar to all or part of methods 500 and 600A-600B described in association with FIG. 5 and FIGS. 6A-6B. For parts or technical effects not described in detail in association with FIG. 14, reference can be made to the relevant descriptions in association with FIG. 5 and FIGS. 6A-6B.

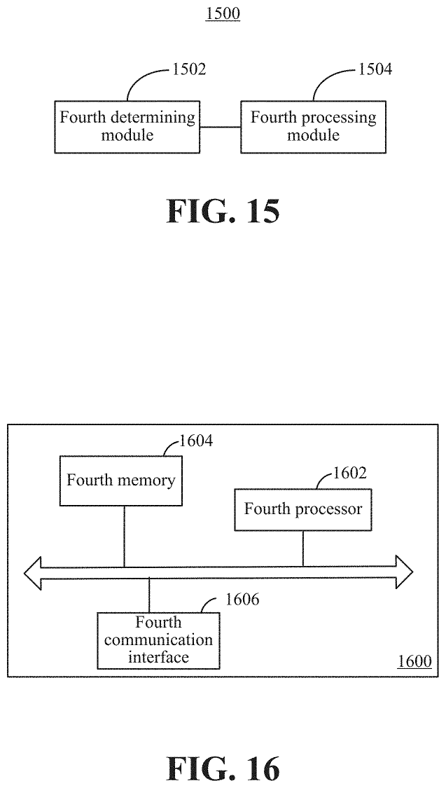

FIG. 15 is a schematic structural diagram of yet another example apparatus 1500 of quantum chip control, consistent with some embodiments of this disclosure. In some embodiments, apparatus 1500 can execute method 1400 described in association with FIG. 14. For parts or technical effects not described in detail in association with FIG. 15, reference can be made to the relevant descriptions in association with FIG. 14.

Apparatus 1500 can include a fourth determining module 1502 and a fourth processing module 1504. Fourth determining module 1502 is configured to determine a processing resource corresponding to a quantum chip control service in response to a request for invoking quantum chip control. Fourth processing module 1504 is configured to perform the following steps based on the processing resource. A chip parameter and a control parameter can be obtained, both of which can be used for controlling the quantum chip to perform operations. A Hamiltonian can be generated based on the chip parameter and the control parameter. Based on the Hamiltonian and the control parameter, the quantum chip can be controlled to perform an operation.

Consistent with some embodiments of this disclosure, the structure of apparatus 1500 in FIG. 15 can be implemented as an electronic device. For example, the electronic device can be a mobile phone, a tablet computer, a server, or any type of other electronic device.

By way of example, FIG. 16 is a schematic structural diagram of an example electronic device 1600 corresponding to apparatus 1500 of FIG. 15. As shown in FIG. 16, electronic device 1600 includes a fourth processor 1602, a fourth memory 1604, and a fourth communication interface 1606. Fourth communication interface 1606 can enable electronic device 1600 to communicate with another device or a communication network. In some embodiments, fourth memory 1604 can store a program for causing electronic device 1600 to execute all or part of the steps in method 1400 described in association with FIG. 14.

Fourth processor 1602 can execute program stored in fourth memory 1604. The program can include one or more computer instructions. By way of example, the one or more computer instructions, when executed by fourth processor 1602, can perform steps 1402-1404 described in association with FIG. 14.

Consistent with some embodiments of this disclosure, a non-transitory computer-readable storage medium can store computer software instructions for use by an electronic device (e.g., electronic device 1600). The computer software instructions can include a program for executing all or part of the steps in method 1400 described in association with FIGS. 11.

In some embodiments, a non-transitory computer-readable storage medium including instructions is also provided, and the instructions can be executed by a device (such as the disclosed encoder and decoder), for performing the above-described methods. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM or any other flash memory, NVRAM, a cache, a register, any other memory chip or cartridge, and networked versions of the same. The device can include one or more processors (CPUs), an input/output interface, a network interface, and/or a memory.

The embodiments can further be described using the following clauses:

1. A non-transitory computer-readable medium storing a set of instructions that is executable by at least one processor of an apparatus to cause the apparatus to perform a method, the method comprising:

obtaining a quantum gate precision corresponding to a quantum chip;

performing a reverse differentiation operation on the quantum gate precision to obtain a gradient of a chip parameter and a gradient of a control parameter, wherein the chip parameter and the control parameter are configured to control the quantum chip to perform operations;

updating the chip parameter based on the gradient of the chip parameter; and

updating the control parameter based on the gradient of the control parameter.

2. The non-transitory computer-readable medium of clause 1, wherein obtaining the quantum gate precision corresponding to the quantum chip comprises:

obtaining an actual quantum gate generated by the quantum chip and a theoretical quantum gate corresponding to the actual quantum gate;

determining a degree of matching between the actual quantum gate and the theoretical quantum gate; and

determining the quantum gate precision based on the degree of matching.

3. The non-transitory computer-readable medium of clause 2, wherein obtaining the actual quantum gate generated by the quantum chip comprises:

obtaining the chip parameter and the control parameter; and

controlling, based on the chip parameter and the control parameter, the quantum chip to perform an operation to obtain the actual quantum gate.

4. The non-transitory computer-readable medium of clause 3, wherein controlling, based on the chip parameter and the control parameter, the quantum chip to perform the operation to obtain the actual quantum gate comprises:

generating a Hamiltonian based on the chip parameter and the control parameter; and

controlling, based on the Hamiltonian and the control parameter, the quantum chip to perform the operation to obtain the actual quantum gate.

5. The non-transitory computer-readable medium of clause 4, wherein the chip parameter comprises at least one of a capacitance corresponding to the quantum chip, an inductance corresponding to the quantum chip, or a parameter corresponding to the quantum chip and used for characterizing energy stored in a Josephson junction.

6. The non-transitory computer-readable medium of clause 4, wherein the control parameter comprises a waveform configured to control the quantum chip to perform the operation.

7. The non-transitory computer-readable medium of clause 4, wherein the gradient of the control parameter is correlated to the Hamiltonian.

8. The non-transitory computer-readable medium of clause 1, wherein the quantum gate precision is configured to identify performance of the quantum chip, and the method further comprises:

in response to obtaining the quantum gate precision corresponding to the quantum chip, performing multiple reverse differentiation operations on the quantum gate precision to obtain a high-order derivative of the chip parameter and a high-order derivative of the control parameter; and

evaluating performance robustness of a quantum gate corresponding to the quantum gate precision based on the high-order derivative of the chip parameter and the high-order derivative of the control parameter.

9. A non-transitory computer-readable medium storing a set of instructions that is executable by at least one processor of an apparatus to cause the apparatus to perform a method, the method comprising:

obtaining a chip parameter and a control parameter, the chip parameter and the control parameter being configured to control a quantum chip to perform operations;

generating a Hamiltonian based on the chip parameter and the control parameter; and

controlling, based on the Hamiltonian and the control parameter, the quantum chip to perform an operation.

10. A non-transitory computer-readable medium storing a set of instructions that is executable by at least one processor of an apparatus to cause the apparatus to perform a method, the method comprising:

in response to a request for invoking parameter optimization, determining a processing resource corresponding to a parameter optimization service; and

based on the processing resource, performing:

obtaining a quantum gate precision corresponding to a quantum chip;

performing a reverse differentiation operation on the quantum gate precision to obtain a gradient of a chip parameter and a gradient of a control parameter, wherein the chip parameter and the control parameter are configured to control the quantum chip to perform operations;

updating the chip parameter based on the gradient of the chip parameter; and

updating the control parameter based on the gradient of the control parameter.

11. A non-transitory computer-readable medium storing a set of instructions that is executable by at least one processor of an apparatus to cause the apparatus to perform a method, the method comprising:

in response to a request for invoking quantum chip control, determining a processing resource corresponding to a quantum chip control service;

based on the processing resource, performing:

obtaining a chip parameter and a control parameter, the chip parameter and the control parameter being configured to control a quantum chip to perform operations;

generating a Hamiltonian based on the chip parameter and the control parameter; and

controlling, based on the Hamiltonian and the control parameter, the quantum chip to perform an operation.

12. An apparatus, comprising:

a memory configured to store a set of instructions; and

one or more processors communicatively coupled to the memory and configured to execute the set of instructions to cause the apparatus to:

obtain a quantum gate precision corresponding to a quantum chip;

perform a reverse differentiation operation on the quantum gate precision to obtain a gradient of a chip parameter and a gradient of a control parameter, wherein the chip parameter and the control parameter are configured to control the quantum chip to perform operations;

update the chip parameter based on the gradient of the chip parameter; and

update the control parameter based on the gradient of the control parameter.

13. The apparatus of clause 12, wherein the one or more processors are further configured to execute the set of instructions to cause the apparatus to:

obtain an actual quantum gate generated by the quantum chip and a theoretical quantum gate corresponding to the actual quantum gate;

determine a degree of matching between the actual quantum gate and the theoretical quantum gate; and

determine the quantum gate precision based on the degree of matching.

14. The apparatus of clause 13, wherein the one or more processors are further configured to execute the set of instructions to cause the apparatus to:

obtain the chip parameter and the control parameter; and

control, based on the chip parameter and the control parameter, the quantum chip to perform an operation to obtain the actual quantum gate.

15. The apparatus of clause 14, wherein the one or more processors are further configured to execute the set of instructions to cause the apparatus to:

generate a Hamiltonian based on the chip parameter and the control parameter; and

control, based on the Hamiltonian and the control parameter, the quantum chip to perform the operation to obtain the actual quantum gate.

16. The apparatus of clause 15, wherein the chip parameter comprises at least one of a capacitance corresponding to the quantum chip, an inductance corresponding to the quantum chip, or a parameter corresponding to the quantum chip and used for characterizing energy stored in a Josephson junction.

17. The apparatus of clause 15, wherein the control parameter comprises a waveform configured to control the quantum chip to perform the operation.

18. The apparatus of clause 15, wherein the gradient of the control parameter is correlated to the Hamiltonian.

19. The apparatus of clause 12, wherein the quantum gate precision is configured to identify performance of the quantum chip, and the method further comprises:

in response to obtaining the quantum gate precision corresponding to the quantum chip, performing multiple reverse differentiation operations on the quantum gate precision to obtain a high-order derivative of the chip parameter and a high-order derivative of the control parameter; and

evaluating performance robustness of a quantum gate corresponding to the quantum gate precision based on the high-order derivative of the chip parameter and the high-order derivative of the control parameter.

20. An apparatus, comprising:

a memory configured to store a set of instructions; and

one or more processors communicatively coupled to the memory and configured to execute the set of instructions to cause the apparatus to:

obtain a chip parameter and a control parameter, the chip parameter and the control parameter being configured to control a quantum chip to perform operations;

generate a Hamiltonian based on the chip parameter and the control parameter; and

control, based on the Hamiltonian and the control parameter, the quantum chip to perform an operation.

21. An apparatus, comprising:

a memory configured to store a set of instructions; and

one or more processors communicatively coupled to the memory and configured to execute the set of instructions to cause the apparatus to:

in response to a request for invoking parameter optimization, determine a processing resource corresponding to a parameter optimization service; and

based on the processing resource, perform:

obtaining a quantum gate precision corresponding to a quantum chip;

performing a reverse differentiation operation on the quantum gate precision to obtain a gradient of a chip parameter and a gradient of a control parameter, wherein the chip parameter and the control parameter are configured to control the quantum chip to perform operations;

updating the chip parameter based on the gradient of the chip parameter; and

updating the control parameter based on the gradient of the control parameter.

22. An apparatus, comprising:

a memory configured to store a set of instructions; and

one or more processors communicatively coupled to the memory and configured to execute the set of instructions to cause the apparatus to:

in response to a request for invoking quantum chip control, determine a processing resource corresponding to a quantum chip control service;

based on the processing resource, perform:

obtaining a chip parameter and a control parameter, the chip parameter and the control parameter being configured to control a quantum chip to perform operations;

generating a Hamiltonian based on the chip parameter and the control parameter; and

controlling, based on the Hamiltonian and the control parameter, the quantum chip to perform an operation.

23. A computer-implemented method for parameter optimization, comprising:

obtaining a quantum gate precision corresponding to a quantum chip;

performing a reverse differentiation operation on the quantum gate precision to obtain a gradient of a chip parameter and a gradient of a control parameter, wherein the chip parameter and the control parameter are configured to control the quantum chip to perform operations;

updating the chip parameter based on the gradient of the chip parameter; and

updating the control parameter based on the gradient of the control parameter.

24. The computer-implemented method of clause 23, wherein obtaining the quantum gate precision corresponding to the quantum chip comprises:

obtaining an actual quantum gate generated by the quantum chip and a theoretical quantum gate corresponding to the actual quantum gate;

determining a degree of matching between the actual quantum gate and the theoretical quantum gate; and

determining the quantum gate precision based on the degree of matching.

25. The computer-implemented method of clause 24, wherein obtaining the actual quantum gate generated by the quantum chip comprises:

obtaining the chip parameter and the control parameter; and

controlling, based on the chip parameter and the control parameter, the quantum chip to perform an operation to obtain the actual quantum gate.

26. The computer-implemented method of clause 25, wherein controlling, based on the chip parameter and the control parameter, the quantum chip to perform the operation to obtain the actual quantum gate comprises:

generating a Hamiltonian based on the chip parameter and the control parameter; and

controlling, based on the Hamiltonian and the control parameter, the quantum chip to perform the operation to obtain the actual quantum gate.

27. The computer-implemented method of clause 26, wherein the chip parameter comprises at least one of a capacitance corresponding to the quantum chip, an inductance corresponding to the quantum chip, or a parameter corresponding to the quantum chip and used for characterizing energy stored in a Josephson junction.

28. The computer-implemented method of clause 26, wherein the control parameter comprises a waveform configured to control the quantum chip to perform the operation.

29. The computer-implemented method of clause 26, wherein the gradient of the control parameter is correlated to the Hamiltonian.

30. The computer-implemented method of clause 23, wherein the quantum gate precision is configured to identify performance of the quantum chip, and the computer-implemented method further comprises:

in response to obtaining the quantum gate precision corresponding to the quantum chip, performing multiple reverse differentiation operations on the quantum gate precision to obtain a high-order derivative of the chip parameter and a high-order derivative of the control parameter; and

evaluating performance robustness of a quantum gate corresponding to the quantum gate precision based on the high-order derivative of the chip parameter and the high-order derivative of the control parameter.

31. A computer-implemented method for controlling a quantum chip, comprising:

obtaining a chip parameter and a control parameter, the chip parameter and the control parameter being configured to control the quantum chip to perform operations;

generating a Hamiltonian based on the chip parameter and the control parameter; and

controlling, based on the Hamiltonian and the control parameter, the quantum chip to perform an operation.

32. A computer-implemented method for parameter optimization, comprising:

in response to a request for invoking parameter optimization, determining a processing resource corresponding to a parameter optimization service; and

based on the processing resource, performing:

obtaining a quantum gate precision corresponding to a quantum chip;

performing a reverse differentiation operation on the quantum gate precision to obtain a gradient of a chip parameter and a gradient of a control parameter, wherein the chip parameter and the control parameter are configured to control the quantum chip to perform operations;

updating the chip parameter based on the gradient of the chip parameter; and

updating the control parameter based on the gradient of the control parameter.

33. A computer-implemented method for controlling a quantum chip, comprising:

in response to a request for invoking quantum chip control, determining a processing resource corresponding to a quantum chip control service;

based on the processing resource, performing:

obtaining a chip parameter and a control parameter, the chip parameter and the control parameter being configured to control a quantum chip to perform operations;

generating a Hamiltonian based on the chip parameter and the control parameter; and

controlling, based on the Hamiltonian and the control parameter, the quantum chip to perform an operation.

The foregoing described device embodiments are merely examples. The units described as separate parts can or cannot be physically separate, and the parts displayed as units can or cannot be physical units, can be located in one position, or can be distributed on a plurality of network units. A part or all of the modules can be selected according to actual requirements to achieve the objectives of the solutions of the embodiments of this disclosure. A person of ordinary skill in the art can understand and implement the embodiments without creative efforts.

Through the description of the foregoing implementations, a person skilled in the art can clearly understand that the implementations can be implemented by software in addition to a necessary universal hardware platform, or by a combination of hardware and software. Based on such an understanding, the foregoing technical solutions essentially, or the part contributing to existing technologies, can be implemented in a form of a software product. This disclosure can use a form of a computer program product that is implemented on one or more computer-usable storage media (including but not limited to a disk memory, a compact disc read-only memory (CD-ROM), an optical memory, and the like) that include computer-usable program code.

This disclosure is described with reference to the flowcharts and/or block diagrams of the methods, the devices (systems), and the computer program products. It should be understood that computer program instructions can implement each procedure and/or block in the flowcharts and/or block diagrams and a combination of procedures and/or blocks in the flowcharts and/or block diagrams. These computer program instructions can be provided for a general-purpose computer, a dedicated computer, an embedded processor, or a processor of any other programmable device to generate a machine, so that the instructions executed by a computer or a processor of any other programmable device generate a device for implementing a function in one or more processes in the flowcharts and/or in one or more blocks in the block diagrams.

These computer program instructions can also be stored in a computer readable memory that can guide a computer or another programmable device to work in a specific manner, so that the instructions stored in the computer readable memory generate a product including an instruction apparatus, where the instruction apparatus implements functions specified in one or more procedures in the flowcharts and/or one or more blocks in the block diagrams.

These computer program instructions can also be loaded into a computer or another programmable device, so that a series of operation steps are performed on the computer or another programmable data processing device to generate processing implemented by a computer, and instructions executed on the computer or another programmable data processing device provide steps for implementing functions specified in one or more procedures in the flowcharts and/or one or more blocks in the block diagrams.

In a typical configuration, the computer device includes one or more processors (CPUs), an input/output interface, a network interface, and a memory.

The internal memory can include forms such as a volatile memory, a random access memory (RAM) and/or a non-volatile memory in computer-readable media, for example, a read-only memory (ROM) or a flash RAM. The internal memory is an example of the computer- readable medium.

The computer-readable medium includes a persistent medium and a non-persistent medium, a removable medium and a non-removable medium, which can implement storage of information by using any method or technology. Information can be a computer-readable instruction, a data structure, a program module, or other data. Examples of computer storage media include but are not limited to a phase change memory (PRAM), a static random access memory (SRAM), a dynamic random access memory (DRAM), other type of random access memory (RAM), a read-only memory (ROM), an electrically erasable programmable read-only memory (EEPROM), a flash memory or other memory technology, a compact disc read-only memory (CD-ROM), a digital versatile disc (DVD) or other optical storage, a cassette magnetic tape, tape and disk storage or other magnetic storage device or any other non-transmission media that can be configured to store information that a computing device can access. Based on the definition in this disclosure, the computer-readable medium does not include transitory computer readable media (transitory media), such as a modulated data signal and a carrier.

Finally, it should be noted that the foregoing embodiments are merely intended for describing the technical solutions of this disclosure, but not for limiting this disclosure. Although this disclosure is described in detail with reference to the foregoing embodiments, a person of ordinary skill in the art should understand that they can still make modifications to the technical solutions described in the foregoing embodiments or make equivalent replacements to some technical features thereof, without departing from the spirit and scope of the technical solutions of the embodiments of this disclosure.

What is claimed is:

1. A non-transitory computer-readable medium storing a set of instructions that is executable by at least one processor of an apparatus to cause the apparatus to perform a method, the method comprising:
obtaining a quantum gate precision corresponding to a quantum chip;
performing a reverse differentiation operation on the quantum gate precision to obtain a gradient of a chip parameter and a gradient of a control parameter, wherein the chip parameter and the control parameter are configured to control the quantum chip to perform operations;
updating the chip parameter based on the gradient of the chip parameter; and
updating the control parameter based on the gradient of the control parameter.

2. The non-transitory computer-readable medium of claim 1, wherein obtaining the quantum gate precision corresponding to the quantum chip comprises:
obtaining an actual quantum gate generated by the quantum chip and a theoretical quantum gate corresponding to the actual quantum gate;
determining a degree of matching between the actual quantum gate and the theoretical quantum gate; and
determining the quantum gate precision based on the degree of matching.

3. The non-transitory computer-readable medium of claim 2, wherein obtaining the actual quantum gate generated by the quantum chip comprises:
obtaining the chip parameter and the control parameter; and
controlling, based on the chip parameter and the control parameter, the quantum chip to perform an operation to obtain the actual quantum gate.

4. The non-transitory computer-readable medium of claim 3, wherein controlling, based on the chip parameter and the control parameter, the quantum chip to perform the operation to obtain the actual quantum gate comprises:
generating a Hamiltonian based on the chip parameter and the control parameter; and
controlling, based on the Hamiltonian and the control parameter, the quantum chip to perform the operation to obtain the actual quantum gate.

5. The non-transitory computer-readable medium of claim 4, wherein the chip parameter comprises at least one of a capacitance corresponding to the quantum chip, an inductance corresponding to the quantum chip, or a parameter corresponding to the quantum chip and used for characterizing energy stored in a Josephson junction.

6. The non-transitory computer-readable medium of claim 4, wherein the control parameter comprises a waveform configured to control the quantum chip to perform the operation.

7. The non-transitory computer-readable medium of claim 4, wherein the gradient of the control parameter is correlated to the Hamiltonian.

8. The non-transitory computer-readable medium of claim 1, wherein the quantum gate precision is configured to identify performance of the quantum chip, and the method further comprises:
in response to obtaining the quantum gate precision corresponding to the quantum chip, performing multiple reverse differentiation operations on the quantum gate precision to obtain a high-order derivative of the chip parameter and a high-order derivative of the control parameter; and
evaluating performance robustness of a quantum gate corresponding to the quantum gate precision based on the high-order derivative of the chip parameter and the high-order derivative of the control parameter.

9. An apparatus, comprising:
a memory configured to store a set of instructions; and
one or more processors communicatively coupled to the memory and configured to execute the set of instructions to cause the apparatus to:
obtain a quantum gate precision corresponding to a quantum chip;
perform a reverse differentiation operation on the quantum gate precision to obtain a gradient of a chip parameter and a gradient of a control parameter, wherein the chip parameter and the control parameter are configured to control the quantum chip to perform operations;
update the chip parameter based on the gradient of the chip parameter; and
update the control parameter based on the gradient of the control parameter.

10. The apparatus of claim 9, wherein the one or more processors are further configured to execute the set of instructions to cause the apparatus to:
obtain an actual quantum gate generated by the quantum chip and a theoretical quantum gate corresponding to the actual quantum gate;
determine a degree of matching between the actual quantum gate and the theoretical quantum gate; and
determine the quantum gate precision based on the degree of matching.

11. The apparatus of claim 10, wherein the one or more processors are further configured to execute the set of instructions to cause the apparatus to:
obtain the chip parameter and the control parameter; and
control, based on the chip parameter and the control parameter, the quantum chip to perform an operation to obtain the actual quantum gate.

12. The apparatus of claim 11, wherein the one or more processors are further configured to execute the set of instructions to cause the apparatus to:
generate a Hamiltonian based on the chip parameter and the control parameter; and
control, based on the Hamiltonian and the control parameter, the quantum chip to perform the operation to obtain the actual quantum gate.

13. The apparatus of claim 12, wherein the chip parameter comprises at least one of a capacitance corresponding to the quantum chip, an inductance corresponding to the quantum chip, or a parameter corresponding to the quantum chip and used for characterizing energy stored in a Josephson junction.

14. The apparatus of claim 12, wherein the control parameter comprises a waveform configured to control the quantum chip to perform the operation.

15. The apparatus of claim 12, wherein the gradient of the control parameter is correlated to the Hamiltonian.

16. The apparatus of claim 9, wherein the quantum gate precision is configured to identify performance of the quantum chip, and the method further comprises:
in response to obtaining the quantum gate precision corresponding to the quantum chip, performing multiple reverse differentiation operations on the quantum gate precision to obtain a high-order derivative of the chip parameter and a high-order derivative of the control parameter; and
evaluating performance robustness of a quantum gate corresponding to the quantum gate precision based on the high-order derivative of the chip parameter and the high-order derivative of the control parameter.

17. A computer-implemented method for parameter optimization, comprising:
obtaining a quantum gate precision corresponding to a quantum chip;
performing a reverse differentiation operation on the quantum gate precision to obtain a gradient of a chip parameter and a gradient of a control parameter, wherein the chip parameter and the control parameter are configured to control the quantum chip to perform operations;
updating the chip parameter based on the gradient of the chip parameter; and
updating the control parameter based on the gradient of the control parameter.

18. The computer-implemented method of claim 17, wherein obtaining the quantum gate precision corresponding to the quantum chip comprises:
obtaining an actual quantum gate generated by the quantum chip and a theoretical quantum gate corresponding to the actual quantum gate;
determining a degree of matching between the actual quantum gate and the theoretical quantum gate; and
determining the quantum gate precision based on the degree of matching.

19. The computer-implemented method of clause 18, wherein obtaining the actual quantum gate generated by the quantum chip comprises:
obtaining the chip parameter and the control parameter; and
controlling, based on the chip parameter and the control parameter, the quantum chip to perform an operation to obtain the actual quantum gate.

20. The computer-implemented method of clause 19, wherein controlling, based on the chip parameter and the control parameter, the quantum chip to perform the operation to obtain the actual quantum gate comprises:
generating a Hamiltonian based on the chip parameter and the control parameter; and
controlling, based on the Hamiltonian and the control parameter, the quantum chip to perform the operation to obtain the actual quantum gate.
